(19) United States
(12) Patent Application Publication
(10) Pub. No.: US 2006/0018335 A1
(43) Pub. Date: Jan. 26, 2006

(54) Multicast to unicast traffic conversion in a network

(76) Inventors: Christopher D. Koch, Minneapolis, MN (US); Richard Paal, Minneapolis, MN (US); Gayle Livermore, Minneapolis, MN (US); Michael Conner, Maple Grove, MN (US)

Correspondence Address: SHUMAKER & SIEFFERT, P. A., 8425 SEASONS PARKWAY, SUITE 105, ST. PAUL, MN, 55125, US

(21) Appl. No.: 11/046,198

(22) Filed: Jan. 28, 2005

Related U.S. Application Data
(60) Provisional application No. 60/591,284, filed on Jul. 26, 2004.

(51) Int. Cl. H04J 3/26

(52) U.S. Cl. 370/432

(57) ABSTRACT

Techniques are described for converting multicast traffic to unicast traffic at an optical network terminal (ONT) on a passive optical network (PON). A traffic conversion technique, in accordance with the invention, involves formatting a multicast frame of a multicast packet stream transmitted to the ONT to include a MAC destination address of the station requesting the multicast packet stream. By including the MAC destination address of the specific station to which the multicast packet stream is to be transmitted, the multicast packet stream is effectively converted to unicast traffic stream. The traffic conversion techniques are designed to avoid overloading stations on a subscriber Ethernet network that are not participating in a multicast group by sending multicast traffic to the stations requesting the multicast traffic. In this way, the traffic conversion techniques allow common equipment to be used while not overburdening non-participating stations with traffic that needs to be discarded.

This application claims the benefit of U.S. provisional application No. 60/591,284, filed Jul. 26, 2004, the entire content of which is incorporated herein by reference.

### TECHNICAL FIELD

The invention relates to computer networking and, more particularly, to the handling of multicast traffic in a network.

### BACKGROUND

A network, such as a passive optical network (PON), a digital subscriber line (DSL) network, or another non-optical network, can deliver voice, video and other data among multiple network nodes. In the case of a PON, the network nodes are often referred to as optical network terminals (ONTs). The PON can deliver data among multiple ONTs using a common optical fiber link. Passive optical splitters and combiners enable multiple ONTs to share the optical fiber link. An optical line terminal (OLT) transmits information downstream to the ONTs, and receives information transmitted upstream from the ONTs. Each ONT terminates the optical fiber link for a residential or business subscriber, and is sometimes referred to as a subscriber premises node.

Each ONT is connected to one or more subscriber stations, which ultimately receive the voice, video and other data delivered via the PON. An ONT on a PON may receive traffic from several sources. Some sources may be commonly used among several ONTs on a PON. For example, several ONTs may access a common traffic flow associated with switched digital video (SDV) or other multicast streams. Other sources may produce traffic flows that are unique to an individual ONT. For example, an individual ONT may receive web content from an Internet service provider (ISP) or voice data from the public switched telephone network (PSTN).

Offering triple play services, i.e., voice, video, and data, to subscriber premises requires an ONT to deliver both multicast traffic, e.g., IPTV traffic, and unicast traffic, e.g., ISP traffic, downstream to the subscriber stations within a subscriber residence on the same Ethernet interface. Examples of subscriber stations include telephones, set-top boxes, televisions, computers, network appliances, and other devices. The subscriber premises topology is often shared for cost effective distribution of the Ethernet traffic. In a network with voice, vide and data, however, there is more multicast traffic than unicast traffic. The high volume of multicast traffic can be disruptive to stations on the subscriber network that have not requested the multicast traffic. In particular, these stations must filter and discard the multicast traffic at large rates.

### SUMMARY

In general, the invention is directed to techniques for converting multicast traffic to unicast traffic at a network terminal on a network. Offering voice, video, and data to subscriber premises requires a network terminal to send both multicast traffic and unicast traffic downstream to the subscriber residence on the same Ethernet interface. In accordance with the invention, however, traffic conversion techniques are designed to avoid overloading subscriber stations on a subscriber Ethernet network that are not participating in a multicast group.

For example, traffic conversion techniques can be used to convert multicast traffic to unicast traffic, which is then sent to stations that originally requested the multicast traffic. In this way, the traffic conversion techniques allow common network terminal equipment to be used in a mixed voice, video and data environment without burdening subscriber stations with unrequested multicast traffic that needs to be discarded. The network may comprise a passive optical network (PON), a digital subscriber line (DSL) network, or another non-optical network.

Subscriber stations include comparators that monitor broadcast frames, multicast frames, and unicast frames. Conventionally, a multicast frame only includes a multicast group destination address. A subscriber station analyzes a multicast address for a higher order bit that indicates it is a multicast frame. The multicast frame is then passed up to the software engine of the subscriber station for further inspection. If the station is not a member of the multicast group, the station discards the frame. A unicast frame includes a unique station medium access control (MAC) destination address. If the received unicast frame's destination address does not match the station's MAC address, the frame is discarded or ignored at the hardware level.

A traffic conversion technique, in accordance with the invention, involves formatting a multicast frame of a multicast packet stream transmitted to the network terminal to include a MAC destination address of the station requesting the multicast packet stream. By including the MAC destination address of the specific station to which the multicast packet stream is to be transmitted, the multicast packet stream is effectively converted to a unicast traffic stream. The technique may involve replicating the multicast packet stream in the event multiple stations on the subscriber Ethernet network have requested the same multicast stream. In this case, the replicated streams are sent to each of the requesting stations, using individual MAC destination addresses associated with those stations.

In one embodiment, the invention provides a method comprising obtaining a multicast frame of a multicast packet stream, formatting the multicast frame to include an individual destination address of a subscriber station requesting the multicast packet stream, and transmitting the formatted multicast frame to the subscriber station over a subscriber network.

In another embodiment, the invention provides a system comprising means for obtaining a multicast frame of a multicast packet stream, means for formatting the multicast frame to include an individual destination address of a subscriber station requesting the multicast packet stream, and means for transmitting the formatted multicast frame to the subscriber station over a subscriber network.

In a further embodiment, the invention provides a network terminal comprising an input port to obtain a multicast frame of a multicast packet stream, a formatting module to format the multicast frame to include an individual destination address of a subscriber station requesting the multicast packet stream, and an output port to transmit the formatted multicast frame to the subscriber station over a subscriber network.

In an added embodiment, the invention provides a computer-readable medium comprising instructions to cause a processor to obtain a multicast frame of a multicast packet stream, format the multicast frame to include an individual destination address of a subscriber station requesting the multicast packet stream, and transmit the formatted multicast frame to the subscriber station over a subscriber network.

The invention may provide one or more advantages. For example, formatting a multicast frame to include an address of a subscriber station requesting the multicast packet stream allows stations that are not members of the multicast group to quickly discard the multicast frame at the hardware level. In this way, overloading the non-participating stations may be avoided as each station does not need to further inspect the multicast frame before discarding. Furthermore, the invention does not require separate networks, one for multicast and one for unicast, nor substantially modification of multicast traffic requests. As a result, the invention described herein can reduce the burden on stations that do not request multicast traffic without a significant increase in equipment and management costs.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a passive optical network (PON).

FIG. 2 is a block diagram illustrating an exemplary embodiment of a subscriber Ethernet network coupled to an optical network terminal (ONT) of a PON.

FIG. 3 is a block diagram illustrating the ONT of FIG. 2 in great detail.

FIG. 4 illustrates a conventional traffic flow between an ONT and two stations on a subscriber network.

FIG. 5 illustrates a traffic flow between an ONT and two stations on a subscriber network in accordance with an embodiment of the invention.

FIG. 6 is a flow chart illustrating a method for sending multicast traffic to requesting stations on a subscriber network without overloading non-participating stations.

### DETAILED DESCRIPTION

The invention is directed to techniques for converting multicast traffic to unicast traffic at a network terminal on a network. The traffic conversion techniques are designed to avoid overloading subscriber stations on a subscriber Ethernet network that are not participating in a multicast group. Using the traffic conversion techniques, multicast traffic can be sent to stations requesting the multicast traffic. In this way, non-participating subscriber stations are not overburdened with multicast traffic that needs to be discarded. The network may comprise a passive optical network (PON), a digital subscriber line (DSL) network, or any of a variety of other networks. For purposes of illustration, the invention will be described herein in reference to a PON.

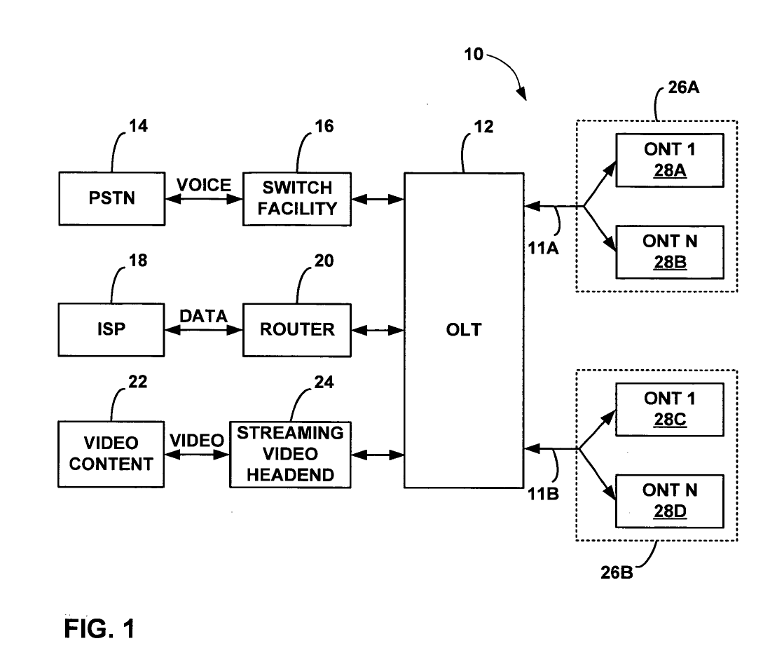

FIG. 1 is a block diagram illustrating a passive optical network (PON) 10. As shown in FIG. 1, PON 10 can be arranged to deliver voice, data and video content (generally “information”) to a number of optical network terminals (ONTs) via optical fiber links. Exemplary components for implementing a PON are commercially available from Optical Solutions, Inc., of Minneapolis, Minn., and designated by the tradename Fiberpath 400™ or Fiberpath 500™, including the Fiberdrive™ headend bay interface and the Fiberpoint™ subscriber premise nodes.

An optical line terminator (OLT) 12 may receive voice information, for example, from the public switched telephone network (PSTN) 14 via a switch facility 16. In addition, OLT 12 may be coupled to one or more Internet service providers (ISPs) 18 via the Internet and a router 20. As further shown in FIG. 1, OLT 12 may receive video content from video content suppliers 22 via a streaming video headend 24. In each case, OLT 12 receives the information, and distributes it along two or more optical fiber links 11A and 11B (collectively “fiber links 11”) to groups 26A and 26B (collectively “groups 26”) of optical network terminals (ONTs) 28A, 28B, 28C and 28D (collectively “ONTs 28”). Each of groups 26 is coupled to a respective one of optical fiber links 11. OLT 12 may be coupled to any number of fiber links 11. Accordingly, FIG. 1 shows only two fiber links 11A, 11B for purposes of illustration.

ONTs 28 include hardware for receiving information from PON 10 via optical fiber links 11, and delivering the information to a connected subscriber station, or one or more connected stations within a local area network (LAN) associated with the ONT. For example, each ONT 28 may serve as a PON access point for one or more computers, network appliances, televisions, set-top boxes, wireless devices, or the like. OLT 12 may be located near or far from a group 26 of ONTs 28. In some existing networks, however, OLT 12 may reside in a central office situated within approximately ten miles from each ONT 28.

An ONT 28 may be located at any of a variety of locations, including residential or business sites, each referred to herein as “subscriber premises.” In addition, a single ONT 28 may operate on a shared basis to deliver information to two or more closely located residences or businesses via copper or additional optical fiber connections, either directly or via a network hub, router or switch. A group 26 of ONTs 28 may refer to nodes served by OLT 12 via a common optical fiber link 11. Each group 26 in FIG. 1 contains two ONTs 28 for purposes of illustration. However, a group 26 may include a single ONT 28, or numerous ONTs.

ONT 28 also may include hardware for transmitting information over PON 10. For example, an ONT 28 may transmit voice information over PSTN 14 via OLT 12 and switch facility 16 in the course of a telephone conversation. In addition, an ONT 28 may transmit data to a variety of ONTs on the Internet via ISP 18, router 20 and OLT 12. Multiple ONTs 28 typically transmit upstream over a common optical fiber link 11 using time division multiplexing techniques.

Offering voice, video, and data to a subscriber premises on an Ethernet network may require an ONT 28 to send both multicast traffic, e.g., video content from video content supplier 22, and unicast traffic, e.g., voice traffic from PSTN 14 or data traffic from ISP 18, downstream to the subscriber stations on the same Ethernet interface. However, in a voice, video and data network, there is ordinarily more multicast traffic than unicast traffic. The high volume of multicast traffic can be disruptive to subscriber stations that have not requested multicast traffic. In particular, all subscriber stations receive the multicast traffic from ONT 28, yet only one or a few of the stations may have actually requested the multicast traffic. In this case, some subscriber stations may expend significant resources in analyzing and discarding the multicast traffic.

In accordance with the invention, ONT 28 provides techniques for converting multicast traffic to unicast traffic for delivery over a subscriber Ethernet network served by the ONT. The traffic conversion techniques involve formatting a multicast frame of a multicast packet stream transmitted to ONT 28 to include a medium access control (MAC) destination address of a particular subscriber station that requested the multicast packet stream. In this way, subscriber stations that are not participating in a multicast group can quickly discard the multicast frame using hardware level filtering. In effect, the reformatted multicast traffic is sent to the subscriber station or stations that requested the traffic, and the processing burden on non-requesting subscriber stations is reduced. By including the MAC destination address of the specific station to which the multicast packet stream is to be transmitted, the multicast packet stream is effectively converted to a unicast traffic stream. Consequently, the multicast packet stream may be ignored by non-participating stations on the network, thereby reducing the processing resources otherwise required to discard the multicast packets.

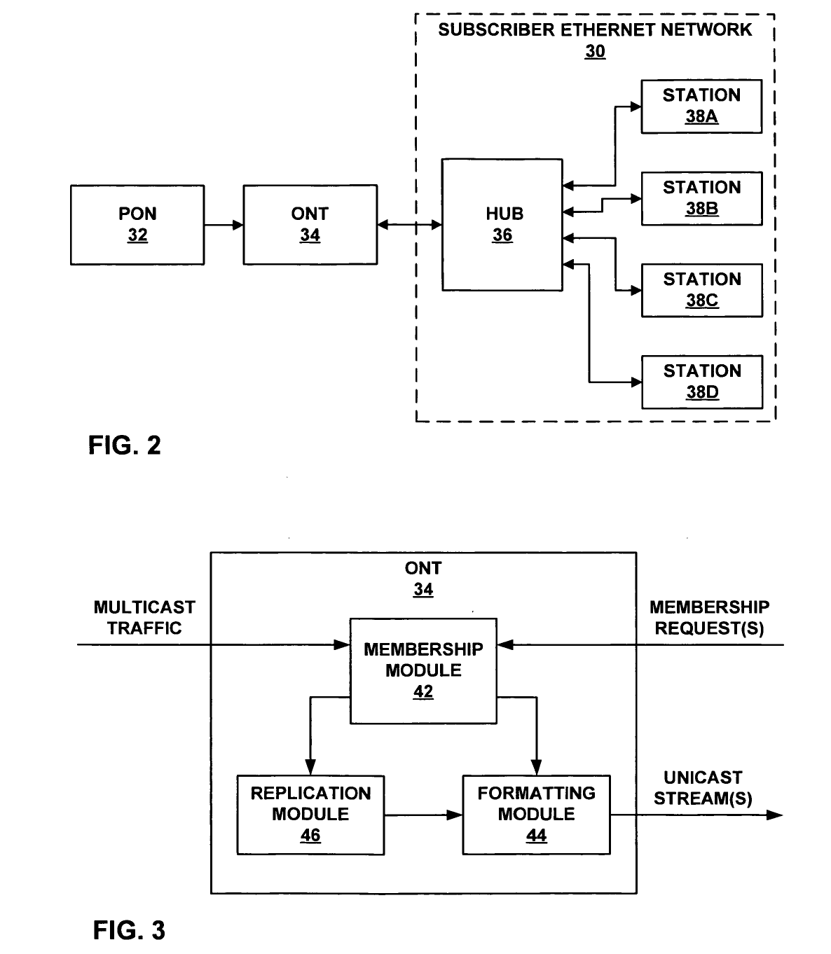

FIG. 2 is a block diagram illustrating an exemplary embodiment of a subscriber Ethernet network 30 coupled to an ONT 34 of a PON 32. PON 32 may operate in a manner substantially similar to PON 10 illustrated in FIG. 1. PON 32 can deliver voice, data, and video content to ONT 34 via an optical fiber link. ONT 34 may then deliver voice, video and data services including both multicast and unicast traffic to subscriber Ethernet network 30 via a single Ethernet interface. Subscriber Ethernet network 30 includes a hub 36 and stations 38A, 38B, 38C, and 38D (collectively “stations 38”). Hub 36 connects stations 38 to an Ethernet port on ONT 34. Each of stations 38 may comprise a computer, network appliance, television, set-top box, wireless device, or the like.

ONT 34 may receive membership requests from at least one of stations 38 to join a multicast group. By joining a multicast group, a station 38 is requesting to receive all multicast packet streams transmitted to ONT 34 corresponding to the multicast group. Each of stations 38 may request membership in one or more multicast groups or no multicast groups. As an example, stations 38 may use an IGMPv2 protocol to request multicast group membership. The ONT Ethernet port listens for membership requests from stations 38. ONT 34 then processes the membership requests and obtains the multicast packet stream corresponding to the pertinent multicast group.

In the case of a conventional ONT, received multicast traffic will be sent to all stations 38. Consequently, stations 38 that are within subscriber Ethernet network 30 and are not members of one of the multicast groups will nevertheless see the multicast traffic anyway. These non-participating stations 38 are burdened with the task of analyzing and discarding the multicast traffic as quickly as it is received. When providing video content to subscriber premises, the multicast traffic is very sizable and can be over 50% of the LAN bandwidth, whereas unicast traffic may be only 1 to 20% of the LAN bandwidth. Therefore, stations 38 not requesting multicast traffic must actively discard the packet streams at very high rates. The need to process and discard unrequested multicast traffic can be disruptive to the operation of the non-requesting stations.

In order to accommodate multicast traffic in an efficient manner, while alleviating the burden on non-participating stations in discarding unrequested multicast packets, ONT 34 is modified to apply a multicast-unicast traffic conversion scheme. In particular, ONT 34 modifies the handling of multicast traffic requests and the formatting of multicast frames to reduce the processing load required by individual stations 38. Notably, ONT 34 permits subscriber stations 38 to operate without substantial modification. For example, subscriber stations 38 are still able to use IGMPv2 requests. In addition, there is no need for separate subscriber networks, one for multicast and one for unicast. As a result, the burden on non-participating stations can be reduced without significantly increasing equipment and management costs.

In operation, ONT 34 converts the multicast packet stream received from PON 32 to a unicast packet stream. In particular, ONT 34 formats each multicast frame in the multicast packet stream to include the MAC destination address of the station 38 requesting the multicast packet stream. If multiple stations 38 have requested the multicast packet stream, ONT 38 replicates the stream for each requesting station, as will be described. ONT 34 transmits the formatted multicast packet streams to the requesting stations 38 via hub 36. The multicast packet stream delivered to ONT 34 from PON 32 retains the IEEE 802.3 multicast frame format and thereby conforms to the IGMPv2 protocol. By formatting each frame for delivery within the subscriber network, ONT 34 avoids overburdening the stations 38 that have not requested membership in the multicast group with multicast traffic.

A subscriber station 38 processes Ethernet frames based on a MAC destination address included in the packet. Ethernet chips for stations ordinarily include comparators that monitor broadcast frames, multicast frames, and unicast frames. These frames are described in the IEEE 802.3 specification. Broadcast frames are designated for all bytes as OXFF or FF:FF:FF:FF:FF:FF. Multicast frames are designated as 01:XX:XX:XX:XX:XX. Unicast frames are designated as 00:XX:XX:XX:XX:XX.

Each station 38 on an Ethernet segment has a globally unique MAC address. The unique MAC address is assigned at the factory or during station configuration. Existing comparators are designed to pass to a station 38 any Ethernet frames that would be “of interest” to the station. Broadcast frames are of interest to the station 38, for example, because there are several protocols, such as address resolution protocol (ARP) and dynamic host configuration protocol (DHCP), that require the use of broadcast addresses.

Conventionally, a multicast frame includes a multicast group destination address. A comparator in a station 38 ordinarily reviews only the higher order bit of a multicast frame to identify the frame as multicast. Because the multicast address space is very large, e.g., greater than 250 million addresses, individual hardware comparators generally are not available for each multicast address of which a station 38 may be a member. Consequently, the hardware comparator typically passes up an identified multicast frame to a software engine within the station 38 for further inspection.

If the station 38 is not a member of the pertinent multicast group, the station discards the frame, but only after analysis by the software engine. A unicast frame, in contrast, includes a unique station medium access control (MAC) destination address. If the received unicast frame's destination address does not match the station's MAC address, the frame is quickly discarded or ignored at the hardware level. Accordingly, by formatting each multicast frame to include the MAC destination address of the requesting station 38, each station can quickly discard the multicast frame using unicast techniques. In particular, each station 38 can apply a hardware comparator to quickly identify multicast packets that were not requested by the station. Hence, a station 38 accepts packets that include the appropriate MAC destination address and discards packets that do not.

If multiple stations 38 have requested the same multicast stream, ONT 34 must replicate the stream and assign pertinent destination MAC addresses to the individual packets to ensure delivery to the appropriate requesting stations 38. At first impression, this approach may appear to be inefficient in terms of bandwidth. However, bandwidth is less of a concern in the subscriber Ethernet network.

There may be several multicast receiver stations on the same subscriber Ethernet network, and each receiver station may request a different multicast stream. As an example, each receiver may be a set-top box (STB), and each STB may request a separate television channel. In this case, there is no sharing of streams, and the subscriber Ethernet network and stations 38 must be designed to handle this worse case scenario. Hence, replication of streams within the subscriber Ethernet network to implement the multicast to unicast traffic conversion scheme, in accordance with the invention, is generally achievable without stressing the bandwidth capabilities of the subscriber network.

Importantly, formatting and replication, if necessary, at the ONT 34 does not affect the way in which PON 32 delivers multicast streams. In a PON network, multicast traffic is the most efficient form of delivery over the PON, because several ONTs 34 that have subscriber stations 38 can share the same stream due to the downstream multicast nature of the PON. Therefore, it is desirable to leave the downstream multicast nature of PON 32 intact for bandwidth efficiency.

To support maintenance of multicast transmission in PON 32, ONT 34 implements the necessary modifications. In particular, ONT 34 provides a modified form of subscriber Ethernet network egress processing to handle multicast requests generated by stations 38. Most devices that make a request to be a part of a multicast group use the IGMPv2 protocol. The Ethernet port of ONT 34 listens for requests from stations 38 requesting to “join” a multicast group. The ONT 34 then processes this request and obtains the multicast stream and sends it out to the Ethernet port in an IEEE 802.3 multicast frame format, which conforms to the IGMPv2 methods.

In accordance with an embodiment of the invention, ONT 34 accepts standard IGMPv2 requests. However, when transmitting the multicast traffic, ONT 34 uses a unicast MAC destination address a station 38 requesting membership instead of a multicast MAC address that corresponds to the multicast group. With this approach, the multicast traffic is sent to the station requesting the multicast traffic and immediately ignored by the other stations 38 not belonging to the multicast group.

The station 38 that requests the multicast packet stream passes the frame up to the software engine for further processing. In contrast, non-requesting stations 38 will not accept the packets at the hardware level, due to a mismatch in the unicast MAC destination address. ONT 34 is aware that each of stations 38 that makes a request for the same multicast group will require replication of the multicast stream to be sent to the station. The transmission of possibly several replicated streams may be bandwidth intensive, relative to a single shared stream. However, as described above, subscriber Ethernet network 30 is designed to handle such a scenario. The advantage of reducing the discard overhead among stations 38 that did not subscribe to a multicast stream generally outweighs any bandwidth issues in Ethernet network 30 associated with multicast replication.

FIG. 3 is a block diagram illustrating ONT 34 from FIG. 2 in greater detail. ONT 34 includes a membership module 42, a formatting module 44, and a replication module 46. Membership module 42, formatting module 44, and replication module 46, as well as other functionality ascribed to ONT 34, may be implemented by one or more general purpose microprocessors, application specific integrated circuits (ASICs), a field programmable logic arrays (FPGAs), or other equivalent integrated or discrete logic circuitry. Accordingly, although some of the functionality of ONT 34 may be described in terms of modules 42, 44, 46, it is understood that such modules be realized as programmable features within a common processor or on separate processors, or by common or separate logic circuitry.

As shown in FIG. 3, membership module 42 receives multicast membership requests from one or more stations 38 via hub 36. ONT 34 receives multicast traffic from PON 32. Formatting module 44 and replication module 46 manipulate the received multicast traffic based on the membership requests received by membership module 42. Membership module 42 accepts standard IGMPv2 requests from stations 38 to join a multicast group. By joining the multicast group, a station 38 is requesting to receive all multicast packet streams transmitted to ONT 34 corresponding to the multicast group.

An Ethernet port on ONT 34 listens for membership requests from stations 38. Membership module 42 then processes the membership requests and ONT 34 obtains the multicast packet stream corresponding to the multicast group from PON 32. Upon receiving a membership request, membership module 42 may store the membership request for a specific station 38. In this way, ONT 34 maintains a record of the particular multicast group or groups to which each station 38 belongs. Membership module 42 then provides the membership information to formatting module 44 and replication module 46.

ONT 34 receives a multicast packet stream from PON 32 at an input port. ONT 34 processes the multicast frame to determine which multicast group corresponds to the multicast packet stream. ONT 34 then applies the membership information from membership module 42 to determine which stations 38 requested the multicast traffic. In the case where only one of stations 38 requested membership in the corresponding multicast group, ONT 34 provides the multicast packet stream to formatting module 44. Formatting module 44 formats the multicast frame of the multicast packet stream to include a MAC destination address of the station 38 that requested the packet stream. The MAC destination address takes the place the multicast group destination address conventionally included in the multicast frame. In this way, ONT 34 may transmit the traffic to the requestor station 38 without overloading non-participating stations on the subscriber LAN with traffic that needs to be discarded.

In some cases, more than one of stations 38 may request membership in the same multicast group. In order to send the corresponding multicast packet stream to each of the requesting stations, ONT 34 provides the multicast packet stream to replication module 46. Replication module 46 replicates the multicast traffic obtained from PON 32 to create a replica for each station 38 that requested the multicast traffic. Replication module 46 uses the membership information from membership module 42 to determine the number of replicas to create. Replication module 46 than provides the replicas to formatting module 44, which formats the multicast frame of each of the replicated multicast packet streams to include a MAC destination address of a corresponding station. ONT 34 transmits the replicated traffic to each of the requesting subscriber stations via an output port.

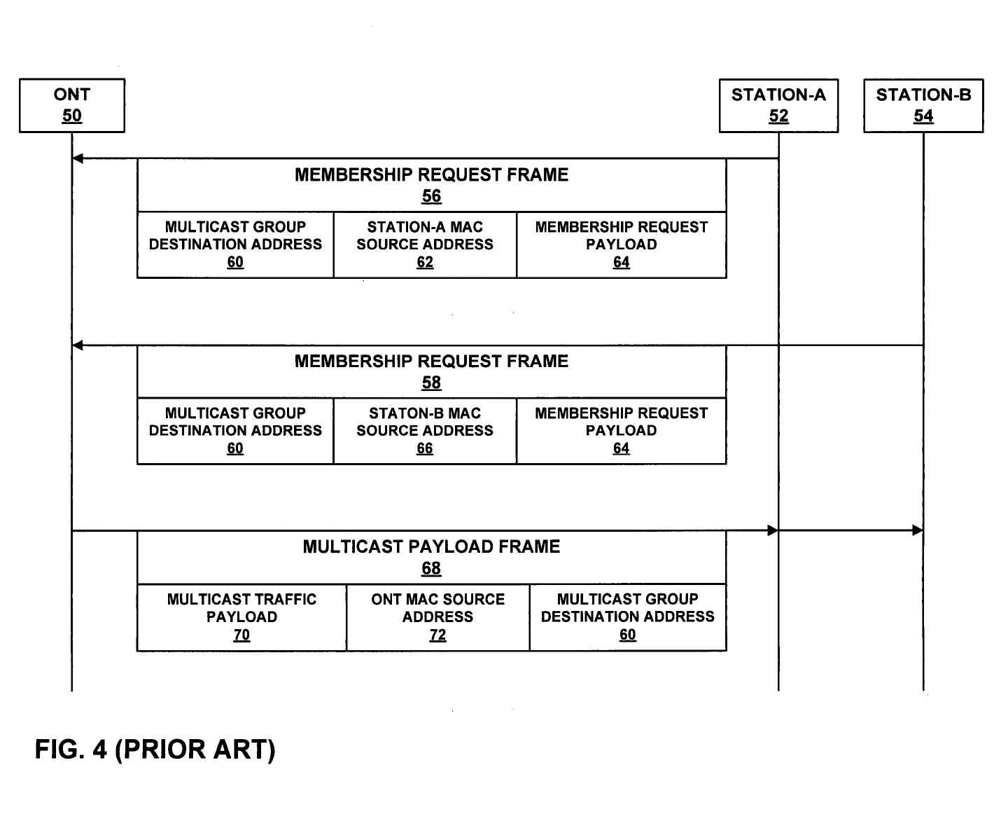

FIG. 4 illustrates conventional traffic flow between an ONT 50 and two subscriber stations 52 and 54 on a subscriber Ethernet network. ONT 50 receives a membership request frame 56 from a station-A 52 to join a multicast group. Membership request frame 56 includes a multicast group destination address 60 that specifies the multicast group in which membership is being requested, a station-A MAC source address 62 that uniquely identifies station-A 52, and a membership request payload 64. ONT 50 also receives a membership request frame 58 from a station-B 54 to join the same multicast group. Membership request frame B 58 includes multicast group destination address 60, a station-B MAC source address 66 that uniquely identifies station-B 54, and membership request payload 64.

Upon receiving membership request frame 56 and membership request frame 58, ONT 50 processes the requests and obtains multicast traffic from PON 32 corresponding to the multicast group joined by station-A 52 and station-B 54. ONT 50 transmits a multicast payload frame 68 to both station-A 52 and station-B 54. Multicast payload frame 68 includes multicast group destination address 60, an ONT MAC source address 72 that uniquely identifies ONT 50, and a multicast traffic payload 70. As shown in FIG. 4, both stations 52 and 54 receive the same multicast payload frame 68.

In cases where station-B 54 does not request membership in the same multicast group as station-A 52, or in any multicast group at all, both stations would still receive the multicast payload frame 68. Again, multicast payload frame 68 only includes multicast group destination address 60. Multicast group destination address 60 is compared only for the higher order bit that indicates that it is a multicast frame. The hardware within each station 52, 54 simply passes up the multicast frame to the software engine of each station 52 and 54 for further inspection. Station-B 54 would then be required to discard multicast payload frame 68. In the case of a voice, video and data network, i.e., a triple play network, the discard rate can be very high, e.g., as high as several packets every millisecond.

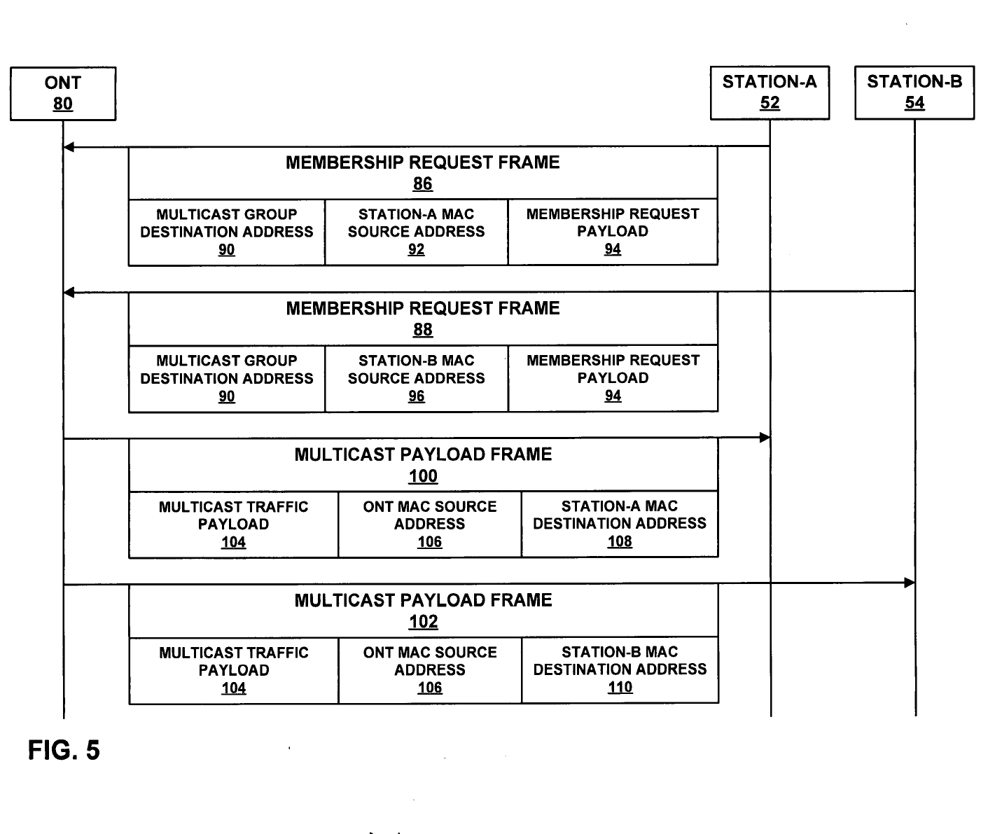

FIG. 5 illustrates traffic flow between an ONT 80 and two stations 52 and 54 on a subscriber network in accordance with an embodiment of the invention. ONT 80 receives a membership request frame 86 from a station-A 52 to join a multicast group. Membership request frame 86 includes a multicast group destination address 90 that specifies the multicast group in which membership is being requested, a station-A MAC source address 92 that uniquely identifies station-A 52, and a membership request payload 94. In the example of FIG. 5, ONT 80 also receives a membership request frame 88 from a station-B 54 to join the same multicast group. Membership request frame 88 includes multicast group destination address 90, a station-B MAC source address 96 that uniquely identifies station-B 54, and membership request payload 94. As can be seen, membership request frames 86 and 88 may be substantially identical to conventional membership request frames 56 and 58 in the example of FIG. 4.

Upon receiving membership request frame 86 and membership request frame 88, ONT 80 processes the requests and obtains multicast traffic from PON 32 corresponding to the multicast group joined by station-A 52 and station-B 54. ONT 80 formats the multicast frame of the received multicast packet stream to include a MAC destination address of the station 52, 54 requesting the multicast traffic. In particular, ONT 80 converts the multicast frame to a unicast frame by replacing the multicast group destination address originally included in the multicast frame with the unique station MAC destination address associated with one of stations 52, 54.

In the illustrated embodiment, both station-A 82 and station-B 54 are requesting the same multicast packet stream. In this case, ONT 80 replicates the received multicast traffic corresponding to the multicast group. One copy of the multicast traffic is formatted to included the MAC destination address of station-A 52 and another copy is formatted to include the MAC destination address of station-B 54. Replication of the multicast stream for unicast transmission to stations 52, 54 is bandwidth intensive. However, the consumption of bandwidth by replication is offset by the reduction in processing overhead at stations 52, 54.

Once the formatting is complete, ONT 80 transmits a multicast payload frame 100 to station-A 52. Multicast payload frame 100 includes a station-A destination address 108 that uniquely identifies station-A 52 as the recipient of the packet stream, an ONT MAC source address 106 that uniquely identifies ONT 80, and a multicast traffic payload 104. Station-A 52 identifies station-A MAC destination address 108 within multicast payload frame 100 and passes multicast payload frame 100 to the software engine for further processing. Station-B 54, on the other hand, identifies a mismatch between the MAC destination address for station-B 54 and the MAC destination address 108 for station-A 52, and discards multicast payload frame 100, e.g., at the hardware level.

ONT 80 also transmits a multicast payload frame 102 to station-B 54. Multicast payload frame 102 includes a MAC destination address 110 that uniquely identifies station-B 54 as the recipient of the packet stream, ONT MAC source address 106, and multicast traffic payload 104. Station-B 54 identifies MAC destination address 110 within multicast payload frame 102 as designated Station-B 54, and passes multicast payload frame 102 to its software engine for further processing. Station-A 53, on the other hand, identifies a mismatch between the MAC destination address 110 for station-B 54 and the MAC destination address for station-A 52, and discards multicast payload frame 102, e.g., at the hardware level.

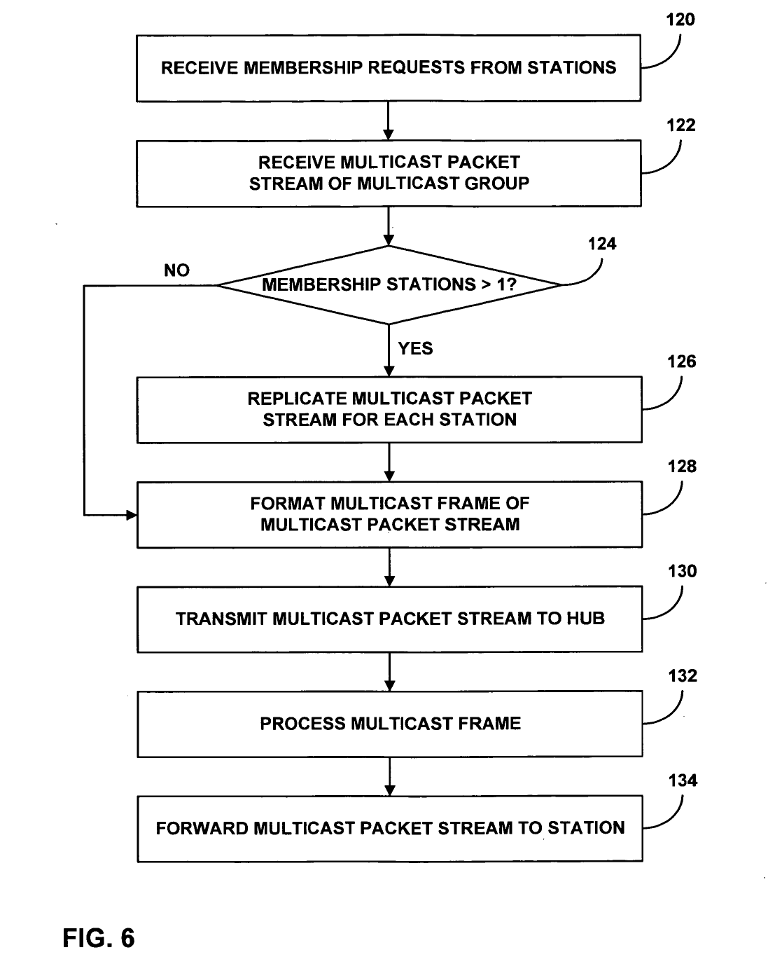

FIG. 6 is a flow chart illustrating a method for sending multicast traffic to stations 38 on a subscriber network 30 without overloading non-participating stations. The method relates to the system illustrated in FIG. 2. As shown in FIG. 6, ONT 34 receives membership requests from at least one of stations 38 to join a multicast group (120). ONT 34 may accept the membership requests in standard IGMPv2 protocol. ONT 34 processes the requests and obtains a multicast packet stream corresponding to the multicast group from PON 32 (122).

ONT 34 then determines if more than one of stations 38 are requesting the received multicast packet stream (124). If two or more of stations 38 are joining the multicast group (yes branch of 124), then ONT 34 replicates the multicast packet stream for each of the requesting stations 38 (126).

Once the multicast packet is replicated, or if only one of stations 38 is a member of the multicast group (no branch of 124), ONT 34 formats a multicast frame of each multicast packet stream (128). ONT 34 formats the multicast frame by including a MAC destination address of the station 38 requesting the multicast traffic. In the case of multiple stations 38 requesting the traffic, ONT 34 formats each of the replicated packet streams to include a different station MAC destination address associated with a respective station 38.

ONT 34 transmits the multicast packet stream to hub 36 of subscriber network 30 (130). Hub 36 processes the multicast frame to read the station MAC destination address included in the frame (132). Once the MAC destination address has been read, hub 36 forwards the multicast packet stream to the one of stations 38 uniquely identified by the MAC destination address (134). Each of the remaining stations 38 on subscriber Ethernet network 30 will discard the multicast packet stream, as it does not include the MAC destination address corresponding to that station.

In this way, the multicast traffic received by ONT 34 will be transmitted only to stations 38 requesting the traffic. Therefore, stations on subscriber network 30 not requesting the multicast traffic will not be burdened with discarding the traffic at high rates. This is especially important in an environment with a large amount of multicast packet streams in the subscriber LAN.

Some aspects of the invention also may be useful in avoiding overburdening a switch with ports coupled to one or more individual subscriber stations. For example, some Ethernet stations on the ONT subscriber side segment may negotiate to lower rates than an Ethernet port on the ONT. For example, the lower rate may be 10 Mbps at a port on the subscriber side segment and 100 Mbps at an ONT port. If the ONT is multicasting to a switch which has one or more stations running at 10 Mbps, and the multicast rate from the ONT exceeds 10 Mbps, the 10 Mbps port on the switch can be overrun. Depending on the switch or hub architecture, exceeding the capacity of the 10 Mbps port can have some significant side effects, including lost packets. Also, some switch architectures may not have buffering schemes that isolate the 10 Mbps ports. Multicast to unicast conversion at the ONT can avoid this problem by preventing the propagation of multicast traffic to 10 Mbps ports.

The various techniques described herein may be implemented by way of instructions carried on a computer-readable medium. Such instructions are formulated to cause a programmable processor to execute the processes described herein. Examples of computer-readable media include random access memory (RAM), read-only memory (ROM), non-memory volatile random access memory (NVRAM), electrically erasable programmable read-only memory (EEPROM), flash memory, and the like, as well as other fixed or removable computer-readable media such as magnetic, optical, magneto-optical, or holographic tape or disk media.

Various embodiments of the invention have been described. However, one skilled in the art will appreciate that various modifications or additions may be made to the described embodiments without departing from the scope of the claimed invention. For example, although described in the context of a PON, the invention may be applicable to a variety of other network environments such as a digital subscriber line (DSL) network or another non-optical network. These and other embodiments are within the scope of the following claims.

1. A method comprising:
obtaining a multicast frame of a multicast packet stream;
formatting the multicast frame to include an individual destination address of a subscriber station requesting the multicast packet stream; and
transmitting the formatted multicast frame to the subscriber station over a subscriber network.

2. The method of claim 1, wherein the individual destination address includes a media access control (MAC) destination address of the subscriber station.

3. The method of claim 1, further comprising receiving a membership request for a multicast group from the subscriber station, wherein the multicast group corresponds to the multicast packet stream, and obtaining a multicast frame includes obtaining a multicast frame in response to the membership request.

4. The method of claim 1, wherein obtaining a multicast frame includes receiving the multicast frame at an optical network terminal (ONT) from a passive optical network (PON), wherein the ONT formats the multicast frame.

5. The method of claim 1, further comprising:
replicating the multicast frame;
formatting the replicating multicast frames to include individual destination addresses of respective subscriber stations; and
transmitting the replicated multicast frames to the subscriber stations over the subscriber network.

6. The method of claim 5, wherein each of the replicated multicast frames includes a different media access control (MAC) destination address identifying a respective subscriber station.

7. The method of claim 1, further comprising:
receiving membership requests for a multicast group associated with the multicast stream packet from multiple subscriber stations;
replicating the multicast frame;
formatting the replicated multicast frames to include individual destination addresses of respective subscriber stations associated with the membership requests; and
transmitting the replicated multicast frames to the subscriber stations over the subscriber network.

8. The method of claim 1, wherein the multicast packet stream includes voice, video, and data packets.

9. The method of claim 1, wherein the subscriber station comprises one of a computer, a network appliance, a television, a set-top box, and a wireless device.

10. A system comprising:
means for obtaining a multicast frame of a multicast packet stream;
means for formatting the multicast frame to include an individual destination address of a subscriber station requesting the multicast packet stream; and
means for transmitting the formatted multicast frame to the subscriber station over a subscriber network.

11. The system of claim 10, wherein the individual destination address includes a media access control (MAC) destination address of the subscriber station.

12. The system of claim 10, wherein the means for obtaining a multicast frame includes an optical network terminal (ONT) coupled to a passive optical network (PON).

13. The system of claim 10, further comprising:
means for replicating the multicast frame;
means for formatting the replicating multicast frames to include individual destination addresses of respective subscriber stations; and
means for transmitting the replicated multicast frames to the subscriber stations over the subscriber network.

14. The system of claim 10, wherein each of the replicated multicast frames includes a different media access control (MAC) destination address identifying a respective subscriber station.

15. The system of claim 10, wherein the multicast packet stream includes voice, video, and data packets.

16. A network terminal comprising:
an input port to obtain a multicast frame of a multicast packet stream;
a formatting module to format the multicast frame to include an individual destination address of a subscriber station requesting the multicast packet stream; and
an output port to transmit the formatted multicast frame to the subscriber station over a subscriber network.

17. The network terminal of claim 16, wherein the individual destination address includes a media access control (MAC) destination address of the subscriber station.

18. The network terminal of claim 16, wherein the network terminal receives a membership request for a multicast group from the subscriber station, wherein the multicast group corresponds to the multicast packet stream, and obtains the multicast frame in response to the membership request.

19. The network terminal of claim 16, wherein the network terminal is an optical network terminal (ONT) and the input port is coupled to a passive optical network (PON).

20. The network terminal of claim 16, further comprising a replication module to replicate the multicast frame, wherein the formatting module formats the replicated multicast frames to include individual destination addresses of respective subscriber stations, and the output port transmits the replicated multicast frames to the subscriber stations over the subscriber network.

21. The network terminal of claim 20, wherein each of the replicated multicast frames includes a different media access control (MAC) destination address identifying a respective subscriber station.

22. The network terminal of claim 16, wherein the multicast packet stream includes voice, video, and data packets.

23. A computer-readable medium comprising instructions to cause a processor to:
obtain a multicast frame of a multicast packet stream;
format the multicast frame to include an individual destination address of a subscriber station requesting the multicast packet stream; and
transmit the formatted multicast frame to the subscriber station over a subscriber network.

24. The computer-readable medium of claim 23, wherein the individual destination address includes a media access control (MAC) destination address of the subscriber station.

25. The computer-readable medium of claim 23, further comprising instructions to cause the processor to receive a membership request for a multicast group from the subscriber station, wherein the multicast group corresponds to the multicast packet stream, and obtain the multicast frame in response to the membership request.

26. The computer-readable medium of claim 23, further comprising instructions to cause the processor to:
replicate the multicast frame;
format the replicating multicast frames to include individual destination addresses of respective subscriber stations; and
transmit the replicated multicast frames to the subscriber stations over the subscriber network.

27. The computer-readable medium of claim 26, wherein each of the replicated multicast frames includes a different media access control (MAC) destination address identifying a respective subscriber station.

28. The computer-readable medium of claim 23, wherein the multicast packet stream includes voice, video, and data packets.
